(19) United States
(12) Patent Application Publication
(10) Pub. No.: US 2007/0246304 A1
(43) Pub. Date: Oct. 25, 2007

(54) Suspension mechanism of screw shaft

(76) Inventor: Chang Hsin Kuo, Taichung (TW)

Correspondence Address: CHARLES E. BAXLEY, ESQ., 90 JOHN STREET, THIRD FLOOR, NEW YORK, NY, 10038, US

(21) Appl. No.: 11/344,659

(22) Filed: Jan. 31, 2006

(51) Int. Cl. B66B 9/02

(52) U.S. Cl. 187/268

(57) ABSTRACT

A suspension mechanism includes an elevator car guided to move up and down relative to an upper supporting member, a screw shaft having an upper end attached to the upper supporting member with a locking nut, a driving nut rotatably supported in a casing and having an inner thread threaded with the screw shaft, and a spring member attached onto the screw shaft and engaged with the upper supporting member for applying a spring-biasing force between the screw shaft and the upper supporting member and for centering the screw shaft relative to the upper supporting member and for preventing a backlash from being generated between the screw shaft and the upper supporting member.

### BACKGROUND OF THE INVENTION

1. Field of the Invention

The present invention relates to a suspension mechanism, and more particularly to a screw shaft suspension mechanism for an elevator system and having a structure for allowing the screw shaft to be easily assembled and for eliminating backlash from being generated or occurred between the screw shaft and a floor or landing or supporting member.

2. Description of the Prior Art

Typical elevator systems comprise a carriage for moving a payload such as personnel or cargo traversely along a vertically elongated structural environment, and a finite length framework along which the vertically movable carriage through a guidable yoke slidably traverses, and one or more upright lugged rails having laterally projecting horizontal lugs spaced at liberal increments-intervals therealong.

For example, U.S. Pat. No. 3,946,836 to Maack discloses one of the typical elevator systems comprising a carriage guided to move up and down along one or more upright lugged rails.

U.S. Pat. No. 4,011,928 to Spear et al. discloses another typical elevator system comprising an elevator car for moving relative to a structure having a number of floors or landings and for being guided to move up and down in a vertical path with T-shaped guide rails and by wire ropes.

In both the typical elevator systems, one or more wire ropes are required to be provided and coupled to the carriage or the elevator car for pulling and suspending the carriage or the elevator car. However, when in use or when the personnel or cargo enters or removed or get out of the carriage or the elevator car, the load applied to the carriage or the elevator car will be changed frequently, such that a backlash will be generated or occurred between the guide rails and the floor or landing or supporting member.

In addition, a number of sidewise forces will also be applied to the carriage or the elevator car such that the carriage or the elevator car may also be forced to move laterally or sidewise relative to the guide rails and the floor or landing or supporting member, and such that a great frictional force will be generated or occurred between the guide rails and the carriage or the elevator car.

The present invention has arisen to mitigate and/or obviate the afore-described disadvantages of the conventional screw shaft suspension mechanisms for elevator systems.

### SUMMARY OF THE INVENTION

The primary objective of the present invention is to provide a screw shaft suspension mechanism for attaching to an elevator system and including a structure for allowing the screw shaft to be easily assembled.

The other objective of the present invention is to provide a screw shaft suspension mechanism for attaching to an elevator system and including a structure for eliminating backlash from being generated or occurred between the screw shaft and a floor or landing or supporting member.

In accordance with one aspect of the invention, there is provided a suspension mechanism comprising. an elevator car to be guided to move up and down relative to an upper supporting member, a screw shaft attached to the upper supporting member and including an outer thread formed on an outer peripheral portion, and including an upper end extended upwardly through the supporting member, a driving nut including an inner thread threaded with the screw shaft and movable up and down along the screw shaft when the driving nut is rotated relative to the screw shaft, a casing rotatably attached onto the driving nut and coupled to the elevator car for moving up and down along the screw shaft together with the driving nut, a locking nut threaded with the upper end of the screw shaft and engaged on top of the upper supporting member, and a spring member attached onto the screw shaft and engaged with the upper supporting member for applying a spring-biasing force between the screw shaft and the upper supporting member and for centering the screw shaft relative to the upper supporting member and for preventing a backlash from being generated between the screw shaft and the upper supporting member.

The locking nut includes a curved surface formed in bottom for engaging with the upper supporting member and for guiding the locking nut and the screw shaft to tilt relative to the upper supporting member and for allowing the screw shaft and the elevator car to be slightly laterally relative to the upper supporting member. The spring member is preferably a compression spring or a disc spring.

The screw shaft includes a lock key secured between the screw shaft and the locking nut for anchoring or securing or positioning the screw shaft and the locking nut together, and thus for preventing the locking nut from being moved or rotated relative to the screw shaft.

The locking nut includes an anchoring notch formed therein, and the upper supporting member includes an anchoring peg extended therefrom and engaged in the anchoring notch of the locking nut for limiting the locking nut to rotate relative to the upper supporting member.

The anchoring peg of the upper supporting member is preferably loosely engaged in the anchoring notch of the locking nut for allowing the locking nut to be tilted relative to the upper supporting member.

The upper supporting member includes an additional spring member attached onto the screw shaft and engaged with an upper portion of the upper supporting member for applying a spring-biasing force between the screw shaft and the upper supporting member.

The outer thread of the screw shaft and the inner thread of the driving nut include a semi-circular shape for slidably receiving balls therein. The casing includes a cushioning member coupled to the elevator car for resiliently coupling the casing to the elevator car.

The casing includes a power driving device attached thereto and coupled to the driving nut for driving and rotating the driving nut relative to the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a suspension mechanism in accordance with the present invention;

FIG. 2 is an enlarged partial cross sectional view of the suspension mechanism;

FIG. 3 is an enlarged partial cross sectional view similar to FIG. 2, illustrating the other arrangement of the suspension mechanism; and

FIG. 4 is a further enlarged partial cross sectional view illustrating the further arrangement of the suspension mechanism.

### DETAILED DESCRIPTION OF THE PREFERRED EMBODIMENT

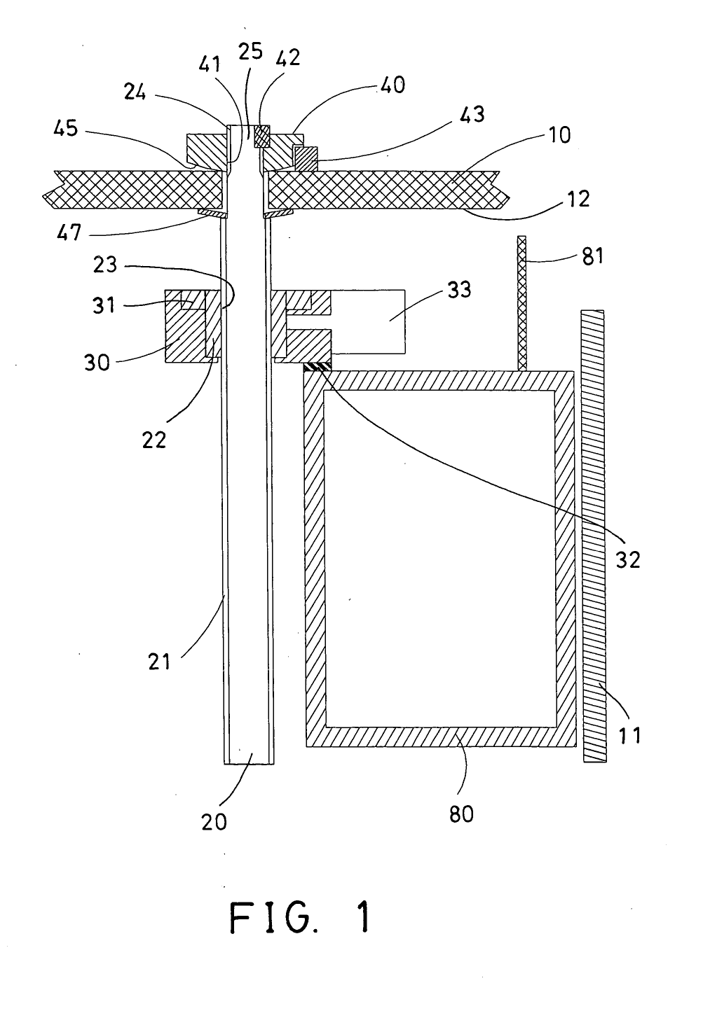

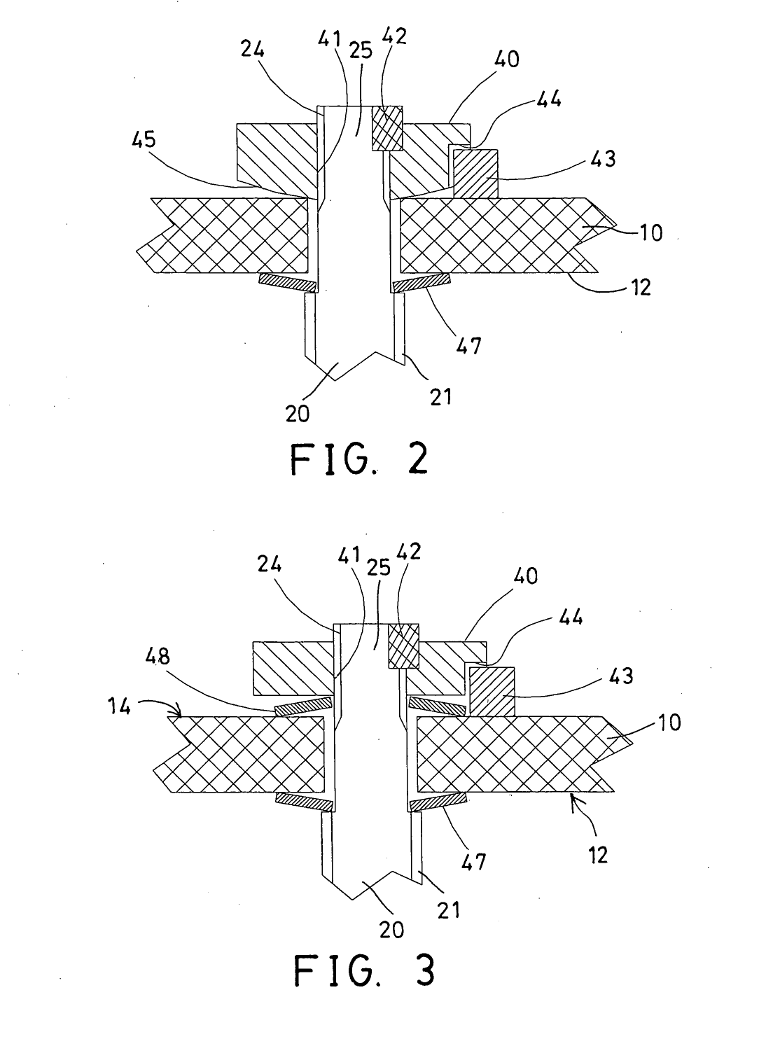

Referring to the drawings, and initially to FIGS. 1 and 2, a suspension mechanism in accordance with the present invention comprises an upper ceiling or supporting member 10, one or more guide rails 11 vertically disposed below the upper supporting member 10 for forming or defining a vertically elongated structural environment, and a carriage or elevator car 80 to be guided to move up and down relative to the upper supporting member 10 and along the guide rails 11 for moving a payload such as personnel or cargo up and down along the vertically elongated structural environment formed or defined by the vertically disposed guide rails 11. One or more typical wire ropes 81 may further be provided and coupled to the carriage or elevator car 80 for safely pulling and suspending the elevator car 80 at selected position.

A screw shaft or threaded member 20 is to be vertically attached to the upper supporting member 10 and includes an outer thread 21 formed on the outer peripheral portion thereof, and a driving nut or threaded member 22 includes an inner thread 23 formed in the inner peripheral portion thereof for threading with the outer thread 21 of the screw shaft 20 and thus for allowing the driving nut 22 to be moved up and down along the screw shaft 20 when the driving nut 22 is rotated relative to the screw shaft 20. Normally, a weight (not shown) will be provided and coupled to the typical wire ropes 81 for balancing purposes and for reducing the burden or the load applied to the screw shaft 20.

A casing 30 is rotatably attached or engaged onto the driving nut 22 and rotatably secured to the driving nut 22 with one or more bearings 31, for allowing the driving nut 22 to be rotated relative to the casing 30. The casing 30 is attached or secured or coupled to the elevator car 80 with a soft or flexible or cushioning member 32 for resiliently coupling the casing 30 to the elevator car 80 and for preventing the casing 30 from being rotated or moved relative to the elevator car 80, but allowing the casing 30 to be slightly moved laterally relative to the elevator car 80.

A power driving means or device 33, such as any selected motor 33 is attached to the casing 30 and coupled to the driving nut 22 with various typical coupling devices, such as pulley-and-belt coupling devices, sprocket-and-chain coupling devices, gearing coupling devices, etc., for driving or rotating the driving nut 22 relative to the casing 30, and thus for driving or moving the casing 30 and thus elevator car 80 up and down along the guide rails 11. The above-described structure is typical and will not be described in further details.

The suspension mechanism in accordance with the present invention is provided for suitably attaching or coupling the screw shaft 20 to the upper supporting member 10 and for preventing a backlash from being generated or occurred between the screw shaft 20 and the upper supporting member 10. It is preferable that the screw shaft 20 includes an outer thread 24 formed or provided at an upper end 25 thereof, and the upper end 25 of the screw shaft 20 includes an outer diameter smaller than the other portions of the screw shaft 20.

For example, a locking nut 40 includes an inner thread 41 formed in the inner peripheral portion thereof for threading with the outer thread 24 at the upper end 25 of the screw shaft 20, and a lock key 42 may be optionally or selectively provided and attached or secured between the screw shaft 20 and the locking nut 40 for keying or anchoring the screw shaft 20 and the locking nut 40 together and for preventing the screw shaft 20 and the locking nut 40 from being rotated relative to each other. The upper end 25 of the screw shaft 20 is extended upwardly through the upper supporting member 10 and threaded to the locking nut 40.

An anchoring peg 43 may further be optionally or selectively provided and attached or secured on the upper supporting member 10 and partially or loosely engaged in an anchoring notch 44 of the locking nut 40 (FIG. 2) for limiting the locking nut 40 to rotate relative to the upper supporting member 10 and arranged for allowing the locking nut 40 to be slightly tilted relative to the upper supporting member 10. The locking nut 40 includes a curved or spherical surface 45 formed or provided in the bottom portion thereof for engaging with the upper supporting member 10 and arranged for guiding the locking nut 40 and thus the screw shaft 20 to tilt or swing relative to the upper supporting member 10, and thus for allowing the screw shaft 20 and the elevator car 80 to be slightly moved laterally relative to the upper supporting member 10 and the guide rails 11.

A spring member 47 may further be provided and attached onto the screw shaft 20 and engaged with the bottom portion 12 of the upper supporting member 10 for applying a resilient or spring- biasing or cushioning force between the screw shaft 20 and the upper supporting member 10 and for biasing the screw shaft 20 backward to the original position relative to the upper supporting member 10, or for centering the screw shaft 20 relative to the upper supporting member 10, and for preventing a backlash from being generated or occurred between the screw shaft 20 and the upper supporting member 10. It is preferable that the spring member 47 is a compression spring or disc spring 47, such as a JIS B 2706 disc spring 47 which includes an inner diameter of 51 mm, an outer diameter of 100 mm, and a thickness of 6.3 mm and which may suffer a load of 1000 Kg with a deformation of only 1.4 mm.

In operation, as shown in FIG. 1, when one or more persons and/or cargo members are entered or removed or get out of the elevator car 80, the load or the weight of the persons or cargo may be applied to the elevator car 80 and may be forced to move the elevator car 80 laterally or sidewise relative to the guide rails 11 and the upper supporting member 10, and the provision of the curved or spherical surface 45 on the bottom portion of the locking nut 40 and/or the attachment of the spring member 47 between the screw shaft 20 and the upper supporting member 10 allows the screw shaft 20 to be tilted or swung relative to the upper supporting member 10, and allows the screw shaft 20 and the elevator car 80 to be slightly moved laterally relative to the upper supporting member 10 and the guide rails 11.

Alternatively, as shown in FIG. 3, without providing the curved or spherical surface 45 on the bottom portion of the locking nut 40, an additional spring member 48 may further be provided and attached onto the screw shaft 20 and engaged with the upper portion 14 of the upper supporting member 10 for applying a resilient or spring-biasing or cushioning force between the screw shaft 20 and the upper supporting member 10 and for biasing the screw shaft 20 backward to the original position relative to the upper supporting member 10, or for centering the screw shaft 20 relative to the upper supporting member 10, and for preventing a backlash from being generated or occurred between the screw shaft 20 and the upper supporting member 10. The spring member 48 is also preferably a disc spring 48.

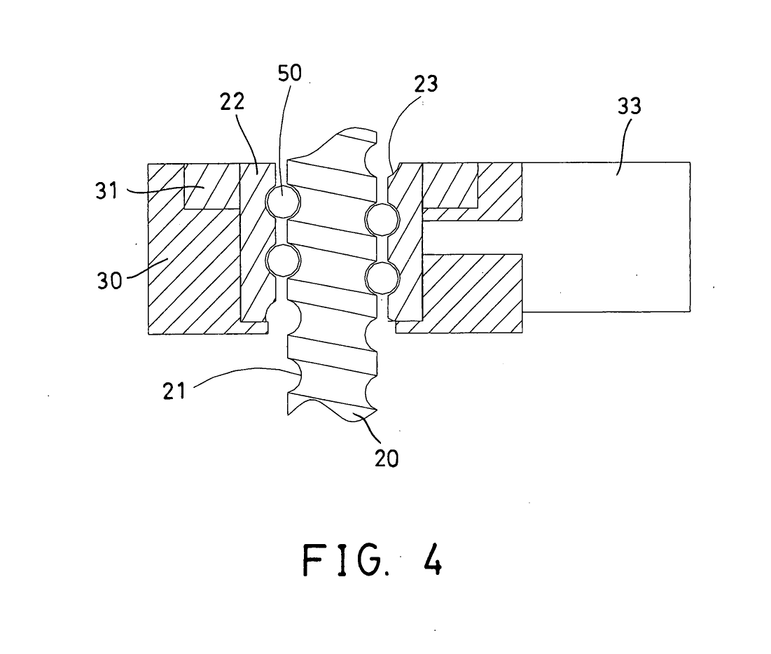

Further alternatively, as shown in FIG. 4, the outer thread 21 of the screw shaft 20 and the inner thread 23 of the driving nut 22 may include a size or dimension good enough for rotatably or slidably receiving one or more rolling members or balls 50 therein, or each may include a semi-circular shape or Gothic shape for rotatably or slidably receiving one or more rolling members or balls 50 therein, in which the balls 50 may be used for lubricating or facilitating the relative movement between the screw shaft 20 and the driving nut 22.

Accordingly, the screw shaft suspension mechanism in accordance with the present invention includes a structure for allowing the screw shaft to be easily assembled and for eliminating backlash from being generated or occurred between the screw shaft and a floor or landing or supporting member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A suspension mechanism comprising:
an upper supporting member including an upper portion and a bottom portion,
an elevator car to be guided to move up and down relative to said upper supporting member,
a screw shaft attached to said upper supporting member and including an outer thread formed on an outer peripheral portion, and including an upper end extended upwardly through said upper supporting member,
a driving nut including an inner thread threaded with said screw shaft and movable up and down along said screw shaft when said driving nut is rotated relative to said screw shaft,
a casing rotatably attached onto the driving nut and coupled to the elevator car for moving up and down along said screw shaft together with said driving nut,
a locking nut threaded with said upper end of said screw shaft and engaged on said upper portion of said upper supporting member, and
a spring member attached onto said screw shaft and engaged with said bottom portion of said upper supporting member for applying a spring-biasing force between said screw shaft and said upper supporting member and for centering said screw shaft relative to said upper supporting member and for preventing a backlash from being generated between said screw shaft and said upper supporting member, and
said locking nut including a curved surface formed in bottom for engaging with said upper supporting member and for guiding said locking nut and said screw shaft to tilt relative to said upper supporting member and for allowing said screw shaft and said elevator car to be moved laterally relative to said upper supporting member.

2-3. (canceled)

4. The suspension mechanism as claimed in claim 1, wherein said spring member is a disc spring.

5. The suspension mechanism as claimed in claim 1, wherein said screw shaft includes a lock key secured between said screw shaft and said locking nut for anchoring said screw shaft and said locking nut together and for preventing said screw shaft and said locking nut from being rotated relative to each other.

6. The suspension mechanism as claimed in claim 1, wherein said locking nut includes an anchoring notch formed therein, and said upper supporting member includes an anchoring peg engaged in said anchoring notch of said locking nut for limiting said locking nut to rotate relative to said upper supporting member.

7. The suspension mechanism as claimed in claim 6, wherein said anchoring peg of said upper supporting member is loosely engaged in said anchoring notch of said locking nut for allowing said locking nut to be tilted relative to said upper supporting member.

8. The suspension mechanism as claimed in claim 1, wherein said upper supporting member includes an additional spring member attached onto said screw shaft and engaged with an upper portion of said upper supporting member for applying a spring-biasing force between said screw shaft and said upper supporting member.

9. The suspension mechanism as claimed in claim 1, wherein said outer thread of said screw shaft and said inner thread of said driving nut include a semi-circular shape for slidably receiving balls therein.

10. The suspension mechanism as claimed in claim 1, wherein said casing includes a cushioning member coupled to said elevator car for resiliently coupling said casing to said elevator car.

11. The suspension mechanism as claimed in claim 1, wherein said casing includes a power driving device attached thereto and coupled to said driving nut for driving and rotating said driving nut relative to said casing.
